(19) United States
(12) Patent Application Publication
(10) Pub. No.: US 2021/0209940 A1
(43) Pub. Date: Jul. 8, 2021

(54) INTER-VEHICLE COMMUNICATION APPARATUS

(71) Applicant: Hitachi Automotive Systems, Ltd., Hitachinaka-shi, Ibaraki (JP)

(72) Inventor: Hideaki TANAKA, Hitachinaka-shi, Ibaraki (JP)

(73) Assignee: Hitachi Automotive Systems, Ltd., Hitachinaka-shi, Ibaraki (JP)

(21) Appl. No.: 17/057,843

(22) PCT Filed: Apr. 24, 2019
(86) PCT No.: PCT/JP2019/017347

§ 371 Date: Nov. 23, 2020

(30) Foreign Application Priority Data
May 28, 2018 (JP) 2018-101281

(51) Int. Cl. G08G 1/01; H04W 4/46; G01C 21/34; G01C 21/36

(52) U.S. Cl. CPC G08G 1/0141; H04W 4/46; G01C 21/3691; G01C 21/3661; G01C 21/3492

(57) ABSTRACT

The invention provides an inter-vehicle communication apparatus for traveling safely and efficiently. In the invention, an inter-vehicle communication apparatus mounted on the vehicle on the information provider side is configured as an “inter-vehicle communication apparatus that includes a communication unit for performing communication by broadcasting, and a storage unit for storing obstacle information during vehicle driving confirmed on a travel route of the own vehicle together with the time and position information, and broadcasts the obstacle information stored in the storage unit from the communication unit”.

### TECHNICAL FIELD

The present invention relates to an inter-vehicle communication apparatus.

### BACKGROUND ART

In recent years, inter-vehicle communication has been put into practical use, and when a construction vehicle notifies the surroundings of information on a position of the own vehicle or a construction section, or when a broken vehicle transmits a state of the own vehicle to the surroundings, a driver or an own vehicle sensor can recognize and avoid an obstacle that cannot be directly detected in advance. For example, it is possible to detect a vehicle stopped due to a breakdown at the end of a curve where visibility is poor by inter-vehicle communication, change lanes, and avoid an obstacle by a wide margin.

However, even though inter-vehicle communication is gradually becoming widespread after introduction to the market, a vehicle involved in a failure such as a broken vehicle or a vehicle detecting the vehicle may not be equipped with an inter-vehicle communication function. Therefore, PTL 1 discloses a technology for determining the presence of an obstacle on a road based on traveling information of a vehicle other than an own vehicle acquired through inter-vehicle communication to improve safety.

In PTL 1, in order to determine the presence of an obstacle on a road based on traveling information of a vehicle other than an own vehicle acquired through inter-vehicle communication, thereby improving safety, “a detection point such as a current position of the own vehicle or a specific position at an intersection is set to attempt inter-vehicle communication with a vehicle around the own vehicle, when inter-vehicle communication is available, a travel trajectory is detected based on a time change of a position of a communication destination vehicle based on vehicle travel information received from the communication destination vehicle, and the presence or absence of an avoidance action against an obstacle (fixed object or moving object) on the road is detected from the travel trajectory, thereby determining the presence or absence (and type) of the obstacle.

Then, information is presented by displaying the presence or absence and type of the obstacle on a display or outputting voice. In particular, in a case where there is an obstacle that requires attention when driving the own vehicle, an alarm is issued to call the attention of a driver.”

### CITATION LIST

### Patent Literature

PTL 1: JP 2007-137139 A

### SUMMARY OF INVENTION

### Technical Problem

However, in the technology of PTL 1, at present, only an obstacle or a traffic condition that can be determined from the behavior of a vehicle existing around the own vehicle can be obtained, and information on a route beyond a communication range of the vehicle cannot be obtained.

Meanwhile, there is a method of collecting obstacle information on a road on a road infrastructure side, integrating the information at a traffic control center, etc., and then notifying vehicles from a roadside machine. However, it takes time to integrate and distribute information, and when an obstacle event occurs information cannot be obtained immediately. In addition, it takes a lot of cost and time to spread infrastructure such as equipment for collecting information or the roadside machine for distributing the information, and it is difficult to deploy the infrastructure on all roads.

The invention has been made in view of such circumstances, and an object of the invention is to provide an inter-vehicle communication apparatus for traveling safely and efficiently.

### Solution to Problem

According to the invention, an inter-vehicle communication apparatus mounted on the vehicle on the information provider side is configured as an “inter-vehicle communication apparatus that includes a communication unit for performing communication by broadcasting, and a storage unit for storing obstacle information during vehicle driving confirmed on a travel route of the own vehicle together with the time and position information, and broadcasts the obstacle information stored in the storage unit from the communication unit”.

In addition, according to the invention, an inter-vehicle communication apparatus mounted on the vehicle on the information requester side is configured as an “inter-vehicle communication apparatus that includes a communication unit for performing communication by broadcasting, and a vehicle surrounding information acquisition unit for confirming that obstacle information is included in a received signal from the communication unit, and is characterized in that the vehicle surrounding information acquisition unit reports the obstacle information to an external display unit or instructs an external vehicle control unit to execute vehicle control for avoiding an obstacle when the obstacle information is generated on a planned travel route of the own vehicle”.

Furthermore, according to the invention, an inter-vehicle communication apparatus having both transmission and reception functions is configured as an “inter-vehicle communication apparatus that includes a communication unit for performing communication by broadcasting, a storage unit for storing obstacle information during vehicle driving confirmed on a travel route of the own vehicle together with the time and position information, and a vehicle surrounding information acquisition unit for obtaining vehicle surrounding information as a received signal from the communication unit, and is characterized in that at least the obstacle information during vehicle driving confirmed on the travel route of the own vehicle is broadcast from the communication unit, and the vehicle surrounding information acquisition unit reports the obstacle information to an external display unit or instructs an external vehicle control unit to execute vehicle control for avoiding an obstacle when the obstacle information is included in the vehicle surrounding information from the communication unit”.

### Advantageous Effects of Invention

According to the invention, it is possible to provide an inter-vehicle communication apparatus for traveling safely and efficiently.

### BRIEF DESCRIPTION OF DRAWINGS

FIG. 1 is a diagram for description of a basic concept in an inter-vehicle communication apparatus of the invention.

FIG. 2 is a diagram illustrating a configuration example of an inter-vehicle communication apparatus according to an embodiment of the invention.

FIG. 3 is a diagram illustrating a processing flow on an information requester side executed by a hardware configuration of FIG. 2.

FIG. 4 is a diagram illustrating a processing flow on an information provider side receiving broadcast of FIG. 3.

FIG. 5 is a diagram illustrating an example of an obstacle case stored in an obstacle information database DB2.

FIG. 6 is a diagram illustrating a processing flow on the information requester side acquiring obstacle information.

### DESCRIPTION OF EMBODIMENTS

Hereinafter, an embodiment of the invention will be described with reference to the drawings.

### Embodiment

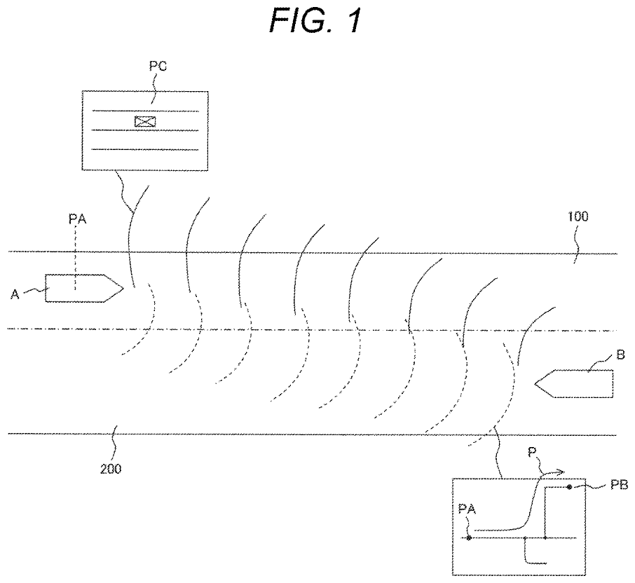

A description will be given of a basic concept in an inter-vehicle communication apparatus of the invention with reference to FIG. 1. Note that the following description will be made on the assumption that all vehicles executing inter-vehicle communication have the same functions as that of the inter-vehicle communication apparatus in the invention.

FIG. 1 illustrates that an own vehicle A is traveling on a lane 100, and is, for example, close to a distance that allows inter-vehicle communication with another vehicle B on an oncoming lane 200. In this case, the own vehicle A on the lane 100 broadcasts at least information on a route P from a current position PA of the own vehicle A to a destination PB.

It is presumed that the other vehicle B on the oncoming lane 200 knows the planned travel route P of the own vehicle A by broadcasting, and holds obstacle confirmation information at a point PC on this route P. In this case, the other vehicle B broadcasts the obstacle confirmation information held by the vehicle.

By broadcasting, the own vehicle A obtains the obstacle confirmation information at the point PC on the route P and displays the information on the own vehicle A or controls the own vehicle A to be able to avoid an obstacle predicted by the obstacle confirmation information at the point PC on the route P.

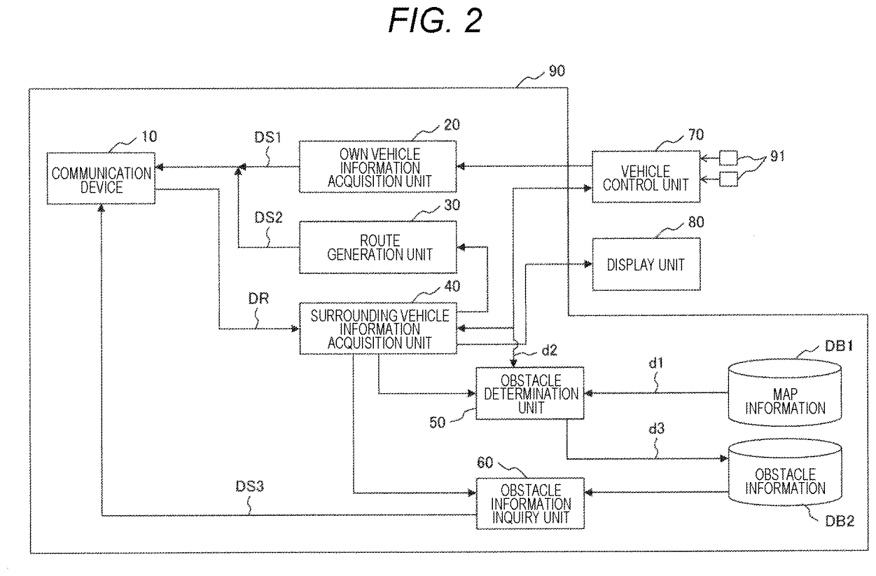

FIG. 2 illustrates an example of a configuration of an inter-vehicle communication apparatus according to an embodiment of the invention capable of executing the above series of functions.

For example, when functions are described in hardware, as illustrated in FIG. 2, an inter-vehicle communication apparatus 90 preferably configured by a computer device includes a communication device 10, an own vehicle information acquisition unit 20, a route generation unit 30, a surrounding vehicle information acquisition unit 40, an obstacle determination unit 50, an obstacle information acquisition unit 60, and a map information database DB1 and an obstacle information database DB2 as databases for storing various types of information. In addition, outside the inter-vehicle communication apparatus 90, a vehicle control unit 70 that controls the vehicle by obtaining information from various sensors 91 provided in the vehicle and a display unit 80 are connected.

In the inter-vehicle communication apparatus 90 of FIG. 2, a plurality of pieces of information is exchanged between vehicles. Information on the planned travel route P in the invention is a part thereof.

Transmitting side information transmitted from the communication device 10 is vehicle information DS1 such as a position and speed of the own vehicle obtained via the vehicle control unit 70 and the own vehicle information acquisition unit 20, information DS2 about the planned travel route P from the route generation unit 30, and obstacle confirmation information DS3 from the obstacle information acquisition unit 60.

In addition, receiving side information received by the communication device 10 is reception information DR, and is appropriately distributed to various places inside the inter-vehicle communication apparatus 90 in the surrounding vehicle information acquisition unit 40.

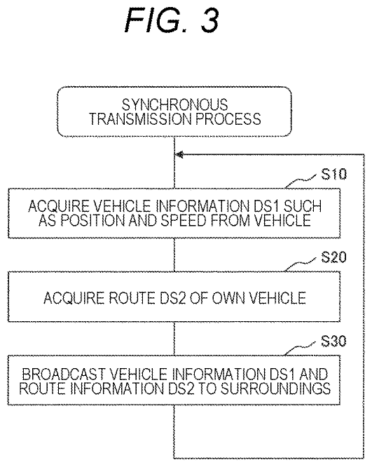

FIG. 3 illustrates a processing flow on an information requester side executed by the hardware configuration of FIG. 2. In FIG. 2, all transmission and reception information to be treated has been described. However, the vehicle information DS1 such as the position and speed of the own vehicle and the information DS2 about the planned travel route P are treated as the information requester side.

In first processing step S10 in the processing flow of FIG. 3, the vehicle information DS1 such as the position and speed of the own vehicle is acquired from the own vehicle A via the own vehicle information acquisition unit 20. Subsequently, in processing step S20, the information DS2 about the route of the own vehicle generated by the route generation unit 30 is acquired. Then, the vehicle information DS1 and the route information DS2 acquired in processing step S10 and processing step S20 are broadcast to the periphery in processing step S30.

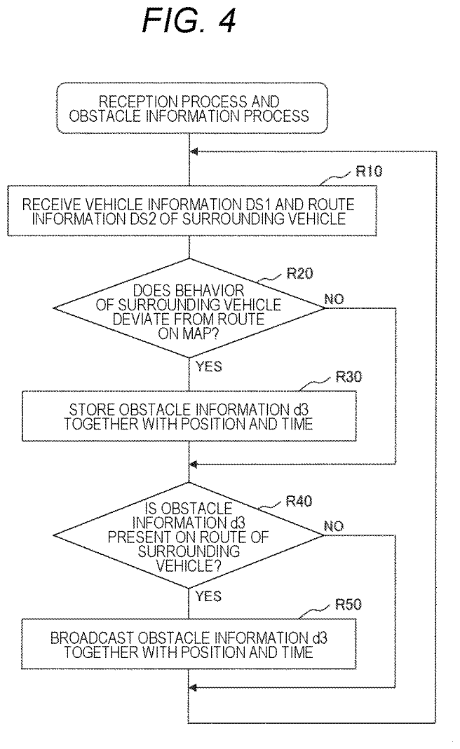

On the other hand, FIG. 4 illustrates a processing flow on an information provider side receiving broadcast of FIG. 3. In FIG. 2, all transmission and reception information to be treated has been described. However, the information provider side of FIG. 4 responds as follows according to the received reception information DR.

In first processing step R10 (corresponding to the function of the surrounding vehicle information acquisition unit 40) in the processing flow of FIG. 4, the vehicle information DS1 and the route information DS2 of the surrounding vehicle are received from the communication device 10.

Meanwhile, in processing step R20 (corresponding to the function of the obstacle determination unit 50), it is determined whether a behavior of the surrounding vehicle deviates from a normal route by comparing with map information d1in the map information database DB1 and a surrounding environment d2 obtained from the own vehicle sensors 91 of the vehicle control unit 70. Then, in the case of deviating, in processing step R30, processing stored in the obstacle information database DB2 as obstacle information d3 together with position and time information is continuously executed.

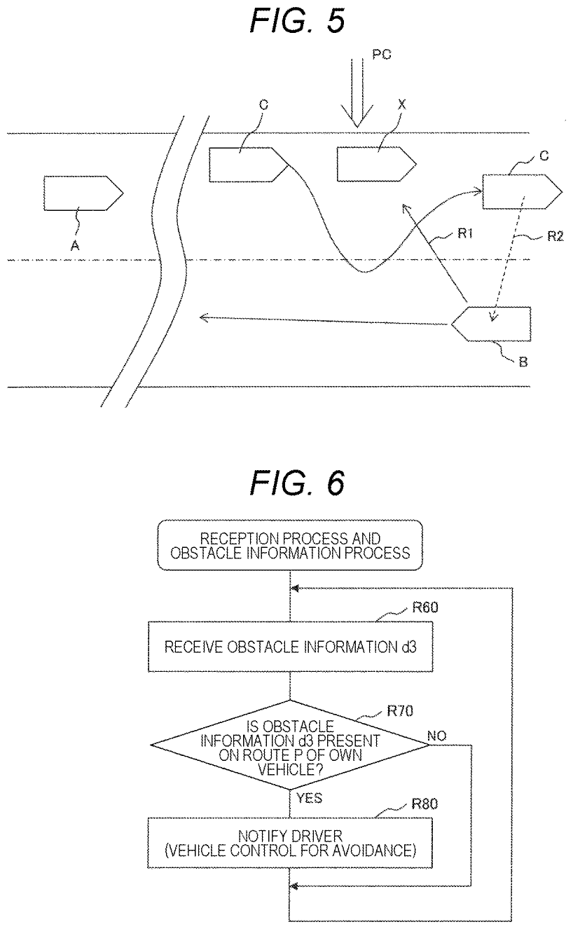

FIG. 5 is a diagram illustrating an example of an obstacle case stored in the obstacle information database DB2 in this way, and the other vehicle B, which is the information provider side, obtains information on the obstacle case at the point PC, which is found to be on the planned travel route P of the own vehicle A later, long before the other vehicle B meets the own vehicle A. The obstacle case in this case is a situation in which a vehicle C preceding the own vehicle A confirms a failed vehicle X, and the vehicle C has to perform a detour operation beyond a center line in order to avoid the failed vehicle X.

In addition, in this case, there is a plurality of possible routes for obtaining the obstacle case, and one of the routes is a route R1 on which the other vehicle B detects detour behavior in the oncoming lane using a camera in the other vehicle B, holds the detour behavior as obstacle information, and transmits the information to the own vehicle A when the other vehicle B encounters the own vehicle A. In addition, another route is a route R2 on which when the vehicle C encounters the other vehicle B after the detour behavior, the other vehicle B is subjected to information transmission (primary transmission) by inter-vehicle communication, and then when the other vehicle B encounters the own vehicle A, information transmission (secondary transmission) by inter-vehicle communication is performed with respect to the own vehicle A. In this case, the obstacle case at the point PC is stored in and transmitted to the other vehicle B together with obstacle content and position/time information.

These obstacle cases are detected by the vehicle control unit 70 based on, for example, sensor signals of a camera sensor, a laser sensor, an acceleration sensor, etc. among the own vehicle sensors 91 of FIG. 2, recognized as obstacle cases in the obstacle determination unit 50, and stored in the obstacle information database DB2.

Naturally, various obstacle cases other than the obstacle cases illustrated in FIG. 5 can be adopted as the obstacle cases stored in the obstacle information database DB2. These obstacle cases may include an obstacle case obtained by the other vehicle B, which is an information provider side, through experience or hearsay long before encounter with the own vehicle A. It suffices that obstacle information that can be confirmed (experience, hearsay, etc.) on a past traffic route of the own vehicle is detected together with the position and time information.

In addition, in processing step R40 (corresponding to the function of an obstacle information inquiry unit 60), whether there is obstacle information on the route P of the own vehicle A notified by the surrounding vehicle (own vehicle A) is checked by referring to the obstacle information database DB2, and when the obstacle information d3 is present, the obstacle information d3 is broadcast from the communication device 10 together with the position and time in processing step R50. Note that in processing of FIG. 4, the obstacle information d3 stored in the own vehicle may be broadcast to the surroundings regardless of the route of the surrounding vehicle. In this case, the surrounding vehicle receiving the obstacle information d3 may appropriately make a selection according to the circumstances of the own vehicle (obstacle on the route).

FIG. 6 is a diagram illustrating a processing flow on the information requester side acquiring the obstacle information. In the processing flow of FIG. 6, the own vehicle A which is the information requester side receives obstacle information from the surrounding vehicle (the other vehicle B) which is the information provider side (processing step R60: corresponding to the function of the communication unit 10), and makes a comparison with the route P of the own vehicle in processing step R70. When the obstacle information d3 is on the route of the own vehicle, the information is displayed or notified to the driver by the display unit 80 in processing step R80 (corresponding to the function of the surrounding vehicle information acquisition unit 40), or in the case of a vehicle in autonomous driving, the own vehicle control unit 70 is operated to control the vehicle, thereby avoiding the obstacle.

Through the above series of processes, the own vehicle A can detect the obstacle information on the route P scheduled to proceed in advance, and can easily take a shunt action.

According to the invention, the inter-vehicle communication apparatus mounted on the vehicle on the information provider side may be configured as an “inter-vehicle communication apparatus that includes a communication unit for performing communication by broadcasting, and a storage unit for storing obstacle information during vehicle driving confirmed on a travel route of the own vehicle together with the time and position information, and broadcasts the obstacle information stored in the storage unit from the communication unit”. Note that in this case, transmission of the obstacle information by broadcasting may be performed on the condition that content received by broadcasting includes a planned travel route of the vehicle on the transmission side, or may be voluntarily performed.

In addition, according to the invention, the inter-vehicle communication apparatus mounted on the vehicle on the information requester side is preferably configured as an “inter-vehicle communication apparatus that includes a communication unit for performing communication by broadcasting, and a vehicle surrounding information acquisition unit for confirming that obstacle information is included in a received signal from the communication unit, and is characterized by reporting the obstacle information to an external display unit or instructing an external vehicle control unit to execute vehicle control for avoiding an obstacle when the obstacle information is generated on a planned travel route of the own vehicle”.

Furthermore, according to the invention, an inter-vehicle communication apparatus having both transmission and reception functions is preferably configured as an “inter-vehicle communication apparatus that includes a communication unit for performing communication by broadcasting, a storage unit for storing obstacle information during vehicle driving confirmed on a travel route of the own vehicle together with the time and position information, and a vehicle surrounding information acquisition unit for obtaining vehicle surrounding information as a received signal from the communication unit, and is characterized by broadcasting at least the obstacle information during vehicle driving confirmed on the travel route of the own vehicle from the communication unit, and reporting the obstacle information to an external display unit or instructing an external vehicle control unit to execute vehicle control for avoiding an obstacle when the obstacle information is included in the vehicle surrounding information from the communication unit”.

### REFERENCE SIGNS LIST

10 communication device
20 own vehicle information acquisition unit
30 route generation unit
40 surrounding vehicle information acquisition unit
50 obstacle determination unit
60 obstacle information acquisition unit
DB1 map information database
DB2 obstacle information database
90 inter-vehicle communication apparatus
70 vehicle control unit
80 display unit
90 inter-vehicle communication apparatus
100 lane
200 oncoming lane
A own vehicle
B another vehicle
DB1 map information database
DB2 obstacle information database
P planned travel route
PA current location
PB target location claims

1. An inter-vehicle communication apparatus comprising:
a communication unit for performing communication by broadcasting; and
a storage unit for storing obstacle information during vehicle driving confirmed on a travel route of an own vehicle together with time and position information,
wherein the obstacle information stored in the storage unit is broadcast from the communication unit.

2. The inter-vehicle communication apparatus according to claim 1, wherein when reception information obtained from the communication unit by broadcasting includes information on a planned travel route of another vehicle and the obstacle information on the planned travel route is stored in the storage unit, the obstacle information is broadcast from the communication unit.

3. An inter-vehicle communication apparatus comprising:
a communication unit for performing communication by broadcasting; and
a vehicle surrounding information acquisition unit for confirming that obstacle information is included in a received signal from the communication unit,
wherein when the obstacle information is generated on a planned travel route of an own vehicle, the vehicle surrounding information acquisition unit reports the obstacle information to an external display unit or instructs an external vehicle control unit to execute vehicle control for avoiding an obstacle.

4. The inter-vehicle communication apparatus according to claim 3, wherein a transmitted signal broadcast from the communication unit includes information on a planned travel route of the own vehicle.

5. An inter-vehicle communication apparatus comprising:
a communication unit for performing communication by broadcasting;
a storage unit for storing obstacle information during vehicle driving confirmed on a travel route of an own vehicle together with time and position information; and
a vehicle surrounding information acquisition unit for obtaining vehicle surrounding information as a received signal from the communication unit,
wherein at least the obstacle information during vehicle driving confirmed on the travel route of the own vehicle is broadcast from the communication unit, and when the obstacle information is included in the vehicle surrounding information from the communication unit, the vehicle surrounding information acquisition unit reports the obstacle information to an external display unit or instructs an external vehicle control unit to execute vehicle control for avoiding an obstacle.

6. The inter-vehicle communication apparatus according to claim 5, wherein at least a planned travel route of the own vehicle is broadcast from the communication unit.
